(19) United States
(12) Patent Application Publication
(10) Pub. No.: US 2012/0295593 A1
(43) Pub. Date: Nov. 22, 2012

(54) METHOD AND SYSTEM FOR PLAYING A MEDIA FILE AND TARGETED ADVERTISEMENTS UPON RECEIPT OF A PHONE CALL

(76) Inventors: Danny Duenas, Homestead, FL (US); Jose Duenas, Mount Dora, FL (US)

(21) Appl. No.: 13/111,952

(22) Filed: May 20, 2011

(51) Int. Cl. H04W 4/00

(52) U.S. Cl. 455/414.1

(57) ABSTRACT

A method and system for playing media files and advertisements upon the receipt of incoming calls is disclosed. In accordance with one embodiment of the present invention, a user may selected specific media files, for instance video files, to play when the user's cellular telephone receives an incoming call whether that call be an audio call, video call, or VoIP call. The user may select specific media files to play when an incoming call is received by the user's cellular telephone. The present invention allows a user to edit a media file starting point to define the point at which the media file will begin to play upon receipt of an incoming call. The present invention also enables a user to download media files in any format directly to the users cellular telephone from an external source such as the internet, a computer, or any other source of digital media, and to create media files using the video or audio recording capabilities of the user's cellular telephone. The present invention also enables the user to utilize 3-Dimensional (“3D”) video media files. The media files may be shuffled to randomize the selection of the media file to play upon receipt of an incoming call. Furthermore, location-based advertisements, which may be further selected using criteria such as age of user, gender of the user, the time of day, the preferences of the user, and the like may be displayed on the cellular telephone screen upon the receipt, during, or directly after an incoming call is received by the cellular telephone. The system of the invention, in alternate embodiments, also utilizes NFC links to display advertisements. The system of the invention may gather information about the cellular telephone user from device text, stored files, email communication, Short Message System (SMS) communication, or other text and information entered into or received by the cellular telephone. In this manner the preferences of the cellular telephone user may be ascertained by the method and system of the invention, and these user preferences may be utilized to select specific advertisements to display at specific times on the cellular telephone display.

### CROSS REFERENCE TO RELATED APPLICATIONS

Not applicable.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to ringtones for cellular telephones, more specifically, the present invention relates to video or other media ringtones that display advertisements on the receipt of an incoming call, during a call, or after a call. The media ringtone may be a portion of any media file, is user-selectable, may be designated to play a specific media file for a specified caller, may contain advertisements that are presented to the user based upon geolocation information, ascertained user preferences based upon the user's history of use of the cellular phone, proximity of vendors, or other selection criteria.

2. Background Art

Cellular telephones are known in the art. Such devices were originally developed to provide mobile telephony services to users who for reasons of preference, convenience or circumstance required wireless connections to a public telephony network. The earliest cellular telephones were dedicated devices that lacked the capability to be used for other purposes.

Cellular telephones also employ Global Positioning System (“GPS”) capabilities enabling the cellular telephone to locate it's geographic position to an accuracy which may be as accurate as a few meters. This GPS information (“geolocation information”) is useful for any number of uses, one such use being that of calculating the distance from the current position of a user to any known location which may be a retail location, restaurant, fuel station, repair station, police or fire facility, hospital or emergent care facility, person, business, or the like.

Furthermore, Near Field Communication (“NFC”) capabilities may also be employed by cellular telephones for purposes of establishing a communication link to another nearby device containing NFC technology through an inductively-coupled data transfer link.

Recent cellular telephones have more advanced operating systems that enable users to enrich and personalize their mobile telephony experience. For example, users can display or play media content such as photos, video clips, and audio files. In fact, a variety of various functions can be implemented in software programs that are loaded into cellular telephone memory. These software programs are termed “applications” and may come pre-loaded into the device memory or may be downloaded into device memory by the user using a variety of communication channels such as the cellular telephone network connection to the internet, by the Radio Frequency link known as Bluetooth®, by infrared link, by hardwire connection to a computer, or by other means well known in the art. Once the applications are loaded into the device memory, the user may enable, or “run”, these applications to perform various intended functions as desired by the user.

One of the most popular ways to personalize a mobile user's telephony experience is to select a unique audio ringtone to be played for incoming calls. The ringtone selected by the user overrides the default ringing sound selected by the telephone manufacturer.

Some cellular telephones run applications that supports the definition of unique ringtones for a specific contact or for groups of contacts. Also, some of these cellular telephones support user definition of a photo or video clip to display when an incoming call is received from a specific contact or group of contacts.

The media files used for these personalization services are available from a variety of sources. A small selection of files is usually pre-loaded on the devices prior to their distribution. The devices also often come equipped with cameras and audio recorders that may be used to create such media files on the devices themselves. Files may also be transferred from other devices in the user's possession via a physical connection or a short range wireless connection technology such as Bluetooth or infra-red. Some media files are also typically downloaded “over the air” across an Internet connection via the connection supplied by the mobile network operator or other media content provider. Some cellular network operators have introduced “ringback” personalization services, which enable a mobile subscriber to define the audio clip that the network operator will play instead of the normal “ring” for someone calling the subscriber's phone number. Ringtones and Ringback tones are available in other systems as well. SIP (Session Initiation Protocol), which may be used to connect devices for a voice over IP (VoIP) connection, also provides an option for the selection of alternative tones. The alternative tone may be indicated by a URL (universal resource locator) that may be used to download the tone at the time the connection is made. The download may be performed using a different channel than the VoIP connection.

“Endtone” personalization services may soon be offered by network operators. Endtones may include specialized disconnect tones to notify wireless device users that voice and data connections are terminated. Endtones have been announced by Endtone of the United States.

In the context of the present invention, “cellular telephone” means any handheld cellular telephone, tablet, smartphone, Personal Digital Assistant, or the like which has the capability to receive incoming calls.

Systems and methods for playing audio and video ringtones may be found in the prior art. United States Patent Application Publication US 2007/0192428 discloses playing a video clip upon the end of a communication between two users and also discloses playing an audio clip upon the end of a communication between two users. The audio clip may have been downloaded to a device of at least one of the users or it may be selected by a first user for playing on the device of a second user.

Still other systems and methods for demarcating specific portions of a video ringtone to be played upon a specific event may be found in the prior art. U.S. Pat. No. 7,747,290, issued to Lundy, describes a method and apparatus for storing a media file in a device (e.g. a cellular telephone, PDA, or alarm clock) and demarcating a portion of the stored media file as a ringtone, without storing the demarcated portion as a separate media file in the device. Thereafter, in response to detection of an alert at the device, the demarcated portion of the media file may be played out as an alert. The stored media file may be an audio file such that the ringtone is an audio ringtone, a video file such that the ringtone is a video ringtone, or an audio-video file such that the ringtone is an audio-video ringtone. Demarcating the portion of media file may include defining a ringtone start point and a ringtone end point. The ringtone start point and end point may be associated with distinct time stamps or data pointers.

However, in order to monetize the methods for playing media content upon a triggering event, such as the receipt of an incoming call, it is desirable to present advertisements to the user for a fee to be paid by the advertiser. These advertisements may be generic (i.e., “mass” advertisements that are not selected specifically for the user), or they may be specifically selected for the user based upon information about the user that is either entered by the user herself, or ascertained by the method and apparatus of the invention based upon the user's use of the cellular telephone. It is an object of the present invention is to enable the presentation of such advertisements to the user in a manner that is likely to be interesting to the user and thus more valuable to the advertiser, and is therefore more effective than the methods of the prior art. It is a further object of the invention to provide the user a method and apparatus for selecting specific media files to play for a specific individual contact or a group of contacts, for downloading or creating media files, and for demarcating specific portions of media files to be played upon a triggering event such as an incoming call. The method and apparatus of the invention may be implemented for use in cellular telephones, PDAs, computers, tablets, laptop computers, or any other device that receives incoming calls and has the ability to play a media file.

### BRIEF SUMMARY OF THE INVENTION

In accordance with one embodiment of the present invention, a user may select specific media files, for instance video files, to play when the user's cellular telephone receives an incoming call whether that call be an audio call, video call, or VoIP call. The user may select specific media files to play when an incoming call is received by the user's cellular telephone. The present invention allows a user to edit a media file starting point to define the point at which the media file will begin to play upon receipt of an incoming call. The present invention also enables a user to download media files in any format directly to the users cellular telephone from an external source such as the internet, a computer, or any other source of digital media, and to create media files using the video or audio recording capabilities of the user's cellular telephone. The present invention also enables the user to utilize 3-Dimensional (“3D”) video media files. The media files may be shuffled to randomize the selection of the media file to play upon receipt of an incoming call. Furthermore, location-based advertisements, which may be further selected using criteria such as age of user, gender of the user, the time of day, the preferences of the user, and the like may be displayed on the cellular telephone screen upon the receipt, during, or directly after an incoming call is received by the cellular telephone. The system of the invention, in alternate embodiments, also utilizes NFC links to display advertisements. The system of the invention may gather information about the cellular telephone user from device text, stored files, email communication, Short Message System (SMS) communication, or other text and information entered into or received by the cellular telephone. In this manner the preferences of the cellular telephone user may be ascertained by the method and system of the invention, and these user preferences may be utilized to select specific advertisements to display at specific times on the cellular telephone display.

### BRIEF DESCRIPTION OF THE DRAWINGS

A better understanding of the present invention will be realized from the detailed description that follows, taken in conjunction with the accompanying drawings, in which:

FIG. 1 depicts a block diagram of a typical cellular telephone.

FIG. 2 depicts a block diagram of the populating of the cellular telephone media file memory, and the demarcation of starting points for the media clips to be played back upon receipt of an incoming call.

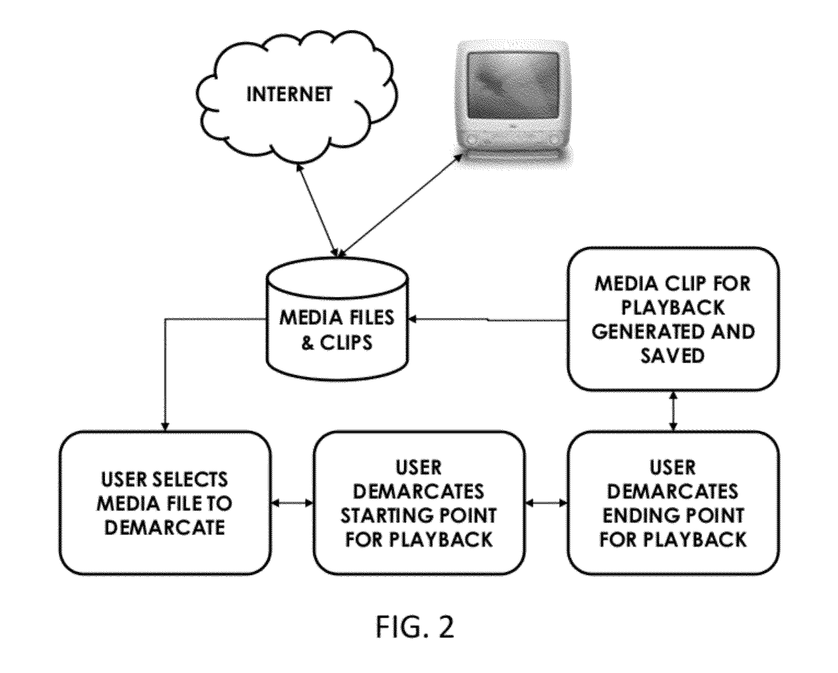

FIG. 3 depicts the menu selections of the User Interface for a preferred embodiment of the invention.

FIG. 4 depicts a state diagram and flow chart for the invention.

FIG. 5 depicts the retrieval of GPS geolocation data for use in selecting an advertisement to display to the user upon receipt of an incoming call.

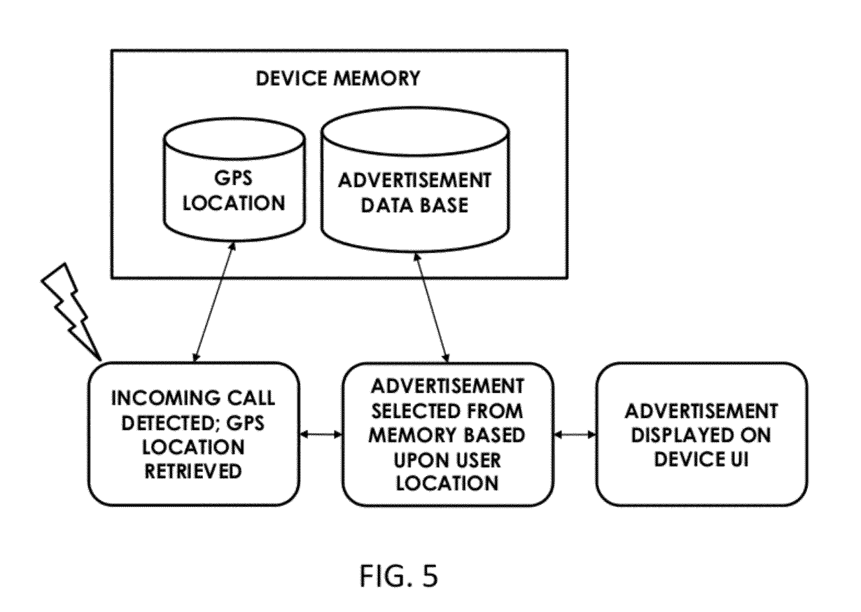

FIG. 6 depicts an opening screenshot of an embodiment of the Application, from which the user can make selections regarding posting his music status to a social media service, seeking Help, finding out more about the service provider in About Us, and viewing the user's media files.

FIG. 7 depicts a continuing screenshot of an embodiment of the Application, from which the user can make selections as to view Incoming Videos, select Shuffle, Make Your Own (media clip), and view and select Downloads.

FIG. 8 depicts a screenshot of an embodiment of the Application, from which the user can select a media file and name the media file for use by the Application.

FIG. 9 depicts a screenshot of an embodiment of the Application, from which the user can select a media file for use as a default ring tone.

FIG. 10 further depicts a screenshot of an embodiment of the Application, from which the user can select a media file for use as a default ring tone.

FIG. 11 depicts a screenshot of an embodiment of the Application from which a user can post his music status to a social media site.

FIG. 12 depicts a continuing screenshot of an embodiment of the Application, from which the user can make selections as to enabling or disabling the Application, viewing his contacts, selecting videos, or continuing to other screens from which the user can make additional selections.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

It is an overall object of the Application to play a media file upon the receipt of a telephone call, said media file being selectable by the user. The user is able to designate a default media file that plays upon the receipt of a telephone call, and also to associate specific media files with specific contacts such that said specific file plays when said specific contact places a telephone call to the user. It is a further object of a preferred embodiment of the invention to display advertisements to the user based upon the user's geolocation and proximity to advertising businesses. It is a further object of the invention to allow a user to select certain portions of media files to play. This is termed “demarcating” and allows the user to select specific portions of the file to play upon the receipt of a telephone call. It is a further object of the invention to collect information about the user from the user's use of input text in other applications running on the cellular telephone, such as web browsing, emailing, or Short Message Server (SMS) communications, and presenting advertisements to the user that are likely to be of interest to the user based upon the user's text input in the other applications on the device.

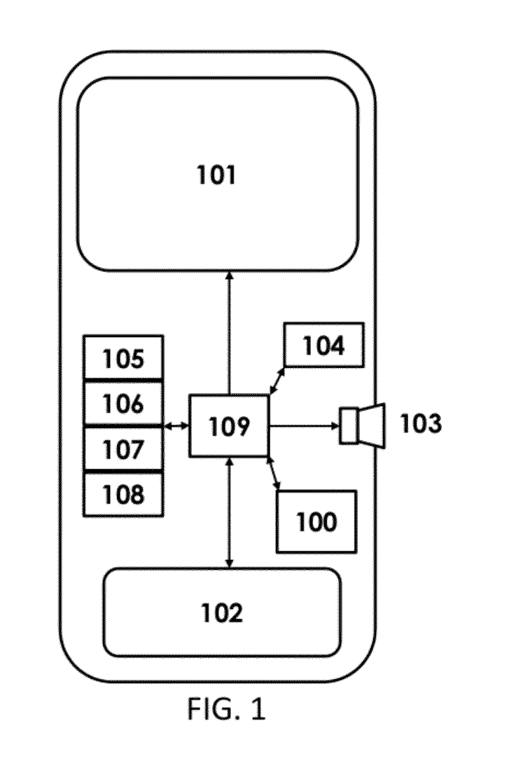

A typical cellular telephone, also referred to as “device” herein, is shown schematically in FIG. 1. Memory 100 is used to store information on the cellular telephone device for later use. Such information may consist of contact information, for example contact name, telephone number, email address, physical address, company information, job title, and so forth. Memory 100 is also used to store other information such as program code, application code, temporary “scratchpad” information used by the device or any of its applications, photographs, media files such as audio or video files, passwords, GPS information, map information, information downloaded from the internet or other external computing devices, or the like. Although Memory 100 may be physically implemented in various and separate semiconductor devices such as Read Only Memory (ROM), Random Access Memory (RAM), Electrically Erasable Programmable Read Only Memory (EEPROM), individual memory registers, FLASH, removable media such as a Secure Digital® card; or other types of physical memory, for the purposes of this disclosure Memory 100 is intended to mean simply the memory of the device without limitation as to its physical implementation.

The typical cellular telephone also utilizes a visual display device, or video screen 101, a keyboard 102 which may be implemented with hard keys, soft keys, or other physical implementations, and an audio playback system 103 that is capable of playing audio files through a device speaker or other audio output.

Still referring to FIG. 1, cellular telephones also typically are comprised of a GPS receiver 104 that is in communication with GPS geolocation satellites, a Bluetooth communication system 105, a cellular telephone system 106, a wireless LAN system 107 and may also be comprised of an NFC system 108. Each of the systems 104, 105, 106, 107 and 108 are typically controlled by a microprocessor, or set of microprocessors, 109. These systems communicate data to and from interconnected devices and system including, but not limited to, computers, other cellular telephones, data networks, and devices, computing devices, and memory connected to data networks.

The physical configuration of the cellular telephone is not intended to be a limitation of the present invention. Thus, for the purposes of this disclosure, any device or system that is capable of receiving an incoming call and is also capable of performing video and audio playback is included in the definition of cellular telephone.

The method and apparatus of the present invention is referred to as the “Application” herein.

The Application is first downloaded onto a user's cellular telephone and stored in memory 100. The download includes the Application code for the method and apparatus of the invention and also may contain advertisements and sample media files that allow the user to quickly implement the invention on her device. From time to time, on a schedule to be determined by the Application code provider, the Application may also automatically check for Application updates or new advertisements, and may prompt the user accept the new Application code and advertisements or may simply load the updated Application code and advertisements without the user's awareness.

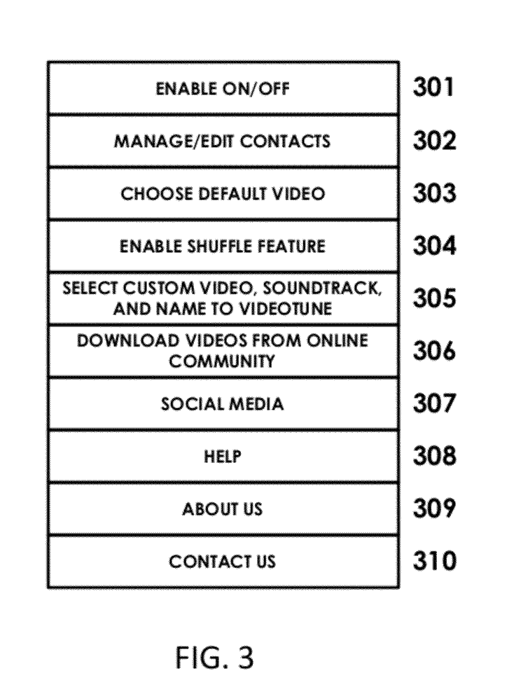

After download, the user may launch the application on her device. In a preferred embodiment of the invention, upon launch the user is presented with a choice of menu functions as shown in FIG. 3, the User Interface (“UI”) which may include: ENABLE ON/OFF 301; MANAGE EDIT CONTACTS 302; CHOOSE DEFAULT VIDEO 303; ENABLE SHUFFLE FEATURE 304; SELECT CUSTOM VIDEO, SOUNDTRACK, AND NAME TO VIDEOTUNE 305; DOWNLOAD VIDEOS FROM ONLINE COMMUNITY 306; SOCIAL MEDIA 307; HELP 308; ABOUT US 309; AND CONTACT US 310. The order of presentation of the menu selections is not a limitation of the invention. Furthermore, it is not intended to be a limitation of the invention that the invention must be comprised of each of the menu items depicted in FIG. 3. The UI of the invention may be comprised of any subset of the menu items shown in FIG. 3, as long as said subset is comprised at least of SELECT CUSTOM VIDEO, SOUNDTRACK, AND NAME TO VIDEOTUNE 305. It is further not a limitation of the invention that the UI utilize the exact names shown in FIG. 3; rather, it is the function of the menu items of FIG. 3 that are elements of the invention.

Referring still to FIG. 3, selecting ENABLE ON/OFF 301 to “ON” activates the Application on the user's cellular telephone. The Application enters a Wait State, in which it waits for a triggering event. The triggering event may be an incoming telephone call, but may also be any other incoming communication event such as the receipt of an SMS message or Instant Message. Selecting ENABLE ON/OFF 301 to “OFF” de-activates the Application on the user's cellular telephone. When the Application is disabled, it does not operate to play media files upon the occurrence of a triggering event, nor does it display advertisements on the device display.

Selecting MANAGE/EDIT CONTACTS 302 allows the user to edit contact information and assign a specific media file to play upon receipt of a triggering event from a specific contact or group of contacts.

Selecting CHOOSE DEFAULT VIDEO 303 allows the user to select from a list of media clips a clip that will play upon the occurrence of a triggering event, such as an incoming telephone call.

Selecting ENABLE SHUFFLE FEATURE 304 allows the user to select a feature of the invention that shuffles playback between selected media clips, said media clips to play upon the occurrence of a triggering event such as an incoming telephone call.

Selecting SELECT CUSTOM VIDEO, SOUNDTRACK, AND NAME TO VIDEOTUNE 305 allows the user to select a specific media clip to play when a specific contact places a call to the user's cellular telephone. In this manner, the user is alerted to that contact's call by the playback of the media clip selected.

Selecting DOWNLOAD VIDEOS FROM ONLINE COMMUNITY 306 allows the user to initiate downloading media files from sources via the internet connection. Such sources may be, for example, online data bases of audio or video files that provide such files for download over the internet. Media files downloaded in this manner are stored in Memory 100 where they can be accessed by the user.

Selecting SOCIAL MEDIA 307 allows the user to post his music status to a social media service such as Facebook or Twitter. By selecting this option, the cellular device will upload the title of the song playing, and may also upload the identification of the artist, to the users social media account for display on the users “status” presence on the site.

Selecting HELP 308 allows the user to access information that describes the functionality of the Application and explains the user controls which are utilized by the user to control the functions of the Application. Such help information is provided to the user in a series of screens that may contain text, graphic images, or combinations of text and graphic images to explain the operation of the Application to the user.

Selecting ABOUT US 209 allows the user to access information that describes the entity providing the Application for download and use.

Selecting CONTACT US 210 allows the user to access information that enables the user to contact the entity providing the Application for download. Such contact information may include telephone number, facsimile number, email address, Skype identity, physical address, and other information allowing the user to contact the providing entity.

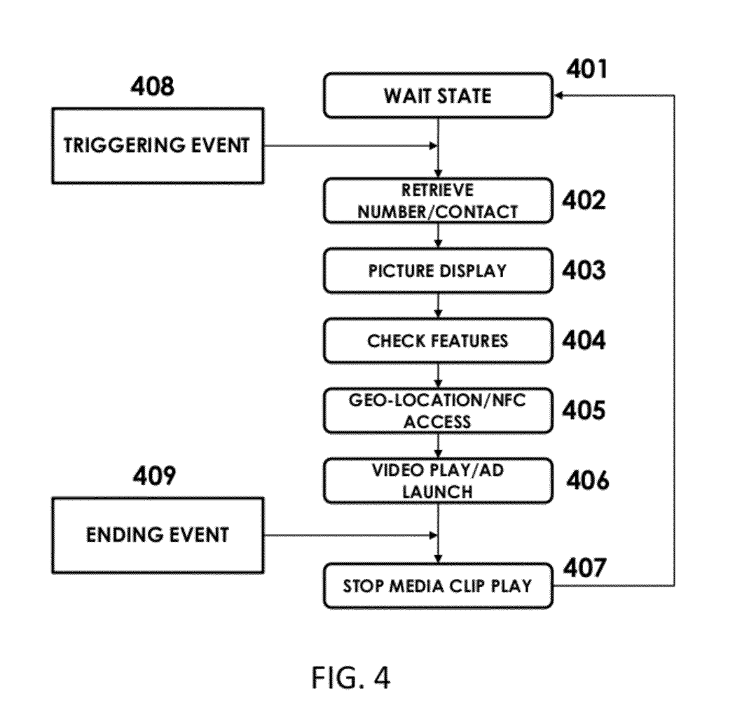

Upon launching of the Application on the device, the Application enters a WAIT state 401 as shown in FIG. 4. In the WAIT state, the Application waits for the occurrence of a triggering event.

Once a triggering event 408 is detected, the Application in step 402 retrieves the telephone number of the contact who has initiated the triggering event which may be, for example, a telephone call. Once the Application has retrieved the telephone number, it may in step 403 display a picture which may have been associated with that contact by the user. The Application also determines if the user has associated a specific media clip with the contact; if the user has associated a media clip with the contact, the Application disables the Shuffler.

Next, the Application in step 404 determines if the Shuffler has been disabled. If the Shuffler has been disabled, the application determines if the Video Editor is enabled.

In step 405, the Application accesses device memory to determine the GPS location of the user, whether there is an active NFC link, determines the time of day, age of user, gender of user, media preferences of the user, and customer trends.

In step 406 the Application launches the media clip which has been associated with the contact and may also launch an advertisement that is selected based upon the time of day, age of user, gender of user, media preferences of the user, and customer trends. The advertisement and media clip will continue to play until the occurrence of an ending event 409 which may be the end of a telephone call; the call is answered; or the calling contact hangs up (ending the call).

Upon the occurrence of ending event 409, the Application returns to WAIT STATE 401.

A further alternate embodiment of the Application utilizes communication systems such as NFC to ascertain when a user is in close proximity to an advertiser. In this context, close proximity is defined as within communication range of the communication system being utilized. The communication system may be NFC, wireless LAN, infrared, cellular networks, Bluetooth, or other communication systems. The particular type of communication system relied upon for this embodiment of the invention is not to be construed as a limitation of the invention. Upon receipt of a triggering event such as an incoming telephone call, the selected media clip associated with the calling contact begins to play. If the communication system senses that the user is in close proximity to an advertiser, the advertisers advertisement is displayed to the user. In this manner special discount may be targeted solely to users of the Application, increasing the value of the Application and resulting in increased usage of the Application and increased revenues to the Application provider.

The Application may come preloaded onto the cellular telephone, or may be downloaded to the cellular telephone through any one of the communication systems present in the cellular telephone, which systems may be, for example, a hardwired interface to a to a computer as in a Universal Serial Bus interface, an infrared communication system, a Bluetooth communication system 105, a cellular telephone system 106, a wireless LAN system 107 or an NFC system 108. These communication systems are disclosed by way of example; it is understood that cellular telephone technology may evolve new or alternative means of communication. The specific communication system utilized to download the Application into the cellular telephone's memory is not to be construed as a limitation of the invention.

A further alternate embodiment of the Application is comprised of a world wide web website interface, wherein the user of the Application may select the Application to download to his cellular telephone, may download media files to the computer for demarcation of beginning and ending points, may save demarcated files for playback, and may download demarcated files to a cellular telephone. In this alternate embodiment, the work of demarcating the files is performed on the computer, which may utilize a faster process than the cellular telephone device, and thus may be an easier interface for the user to utilize for the purpose of demarcating media files and storing them for playback by the Application.

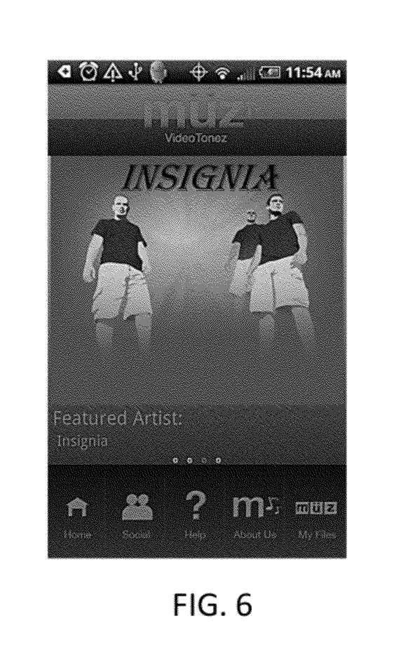

FIG. 6 depicts an opening screenshot of an embodiment of the Application, from which the user can make selections regarding posting his music status to a social media service, seeking Help, finding out more about the service provider in About Us, and viewing the user's media files.

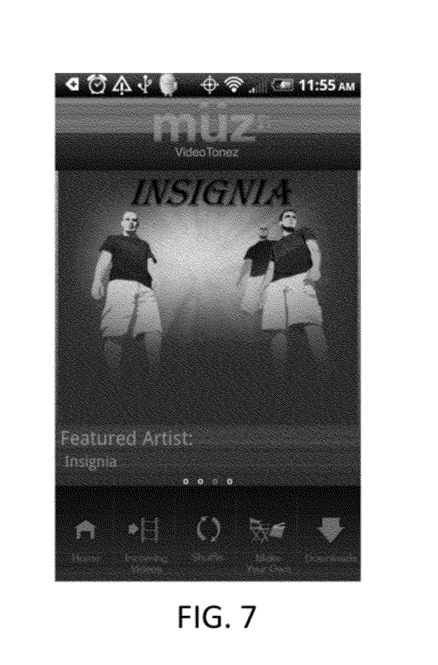

FIG. 7 depicts a continuing screenshot of an embodiment of the Application, from which the user can make selections as to view Incoming Videos, select Shuffle, Make Your Own (media clip), and view and select Downloads.

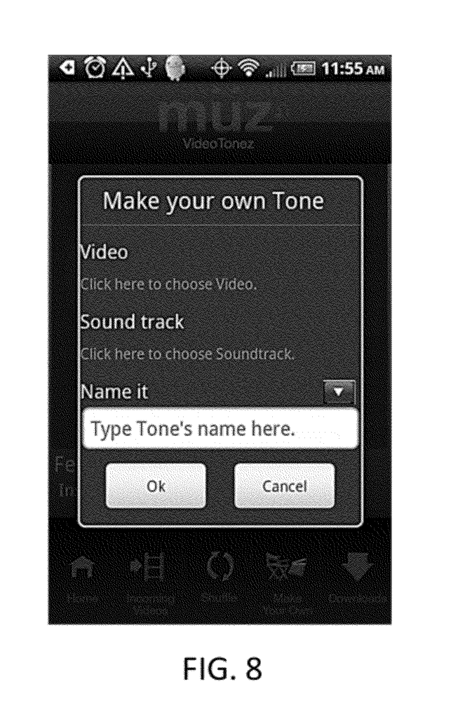

FIG. 8 depicts a screenshot of an embodiment of the Application, from which the user can select a media file and name the media file for use by the Application.

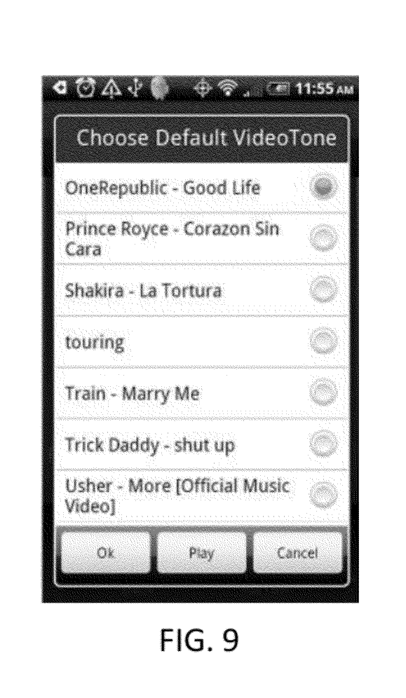

FIG. 9 depicts a screenshot of an embodiment of the Application, from which the user can select a media file for use as a default ring tone.

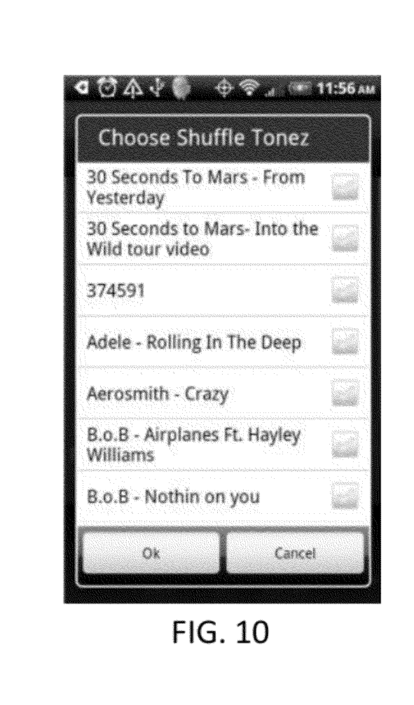

FIG. 10 further depicts a screenshot of an embodiment of the Application, from which the user can select a media file for use as a default ring tone.

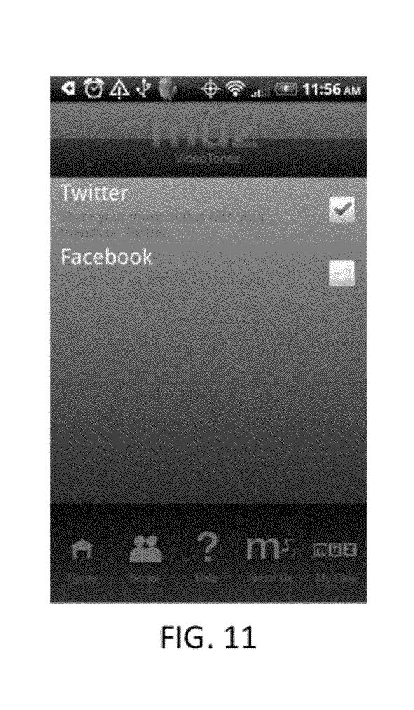

FIG. 11 depicts a screenshot of an embodiment of the Application from which a user can post his music status to a social media site.

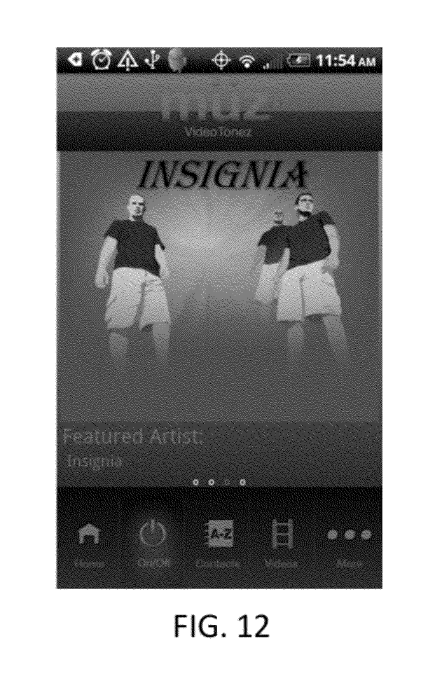

FIG. 12 depicts a continuing screenshot of an embodiment of the Application, from which the user can make selections as to enabling or disabling the Application, viewing his contacts, selecting videos, or continuing to other screens from which the user can make additional selections.

In the preferred embodiment of the invention, upon receipt of a telephone call the Application accesses the user's geolocation information from the cellular telephone's geolocation system. Such geolocatoin systems may rely upon Global Positioning Systems (GPS) information, cellular tower information, information input by the user, or other information. The means by which the Application ascertains the users geolocation information is not to be construed as a limitation of the invention. Once having ascertained the users geolocation information, the Application compares the user's geolocatoin to the geolocation of advertisers who have registered with the system of the invention to determine whether any registered advertisers are within a range to be specified by the advertiser. If an advertiser, or group of advertisers, is located within such range, that advertiser, or group of advertisers, advertisements are presented to the user using the video display of the cellular device, the audio system of the device, or both. The advertisement may be presented at the beginning of a telephone call, during the telephone call, or just after the telephone call. The advertisements presented to the user based upon geolocation information may be presented in order of priority based upon the sales price of the advertisement, the proximity of the advertiser to the user, or an algorithm that combines both. In a further alternate embodiment of the system, the advertisement may provide a special offer to the user in the form of additional services, discounted pricing, preferential treatment, or the like because the user of the Application has chosen the Application to run on his cellular device.

In an alternate embodiment of the system, the user may choose a version of the Application which does not display advertisements, or is limited to display only limited advertisements. Such alternate embodiments may be offered to the user for a small fee. In this manner, the user may elect to pay a small fee in order to avoid advertisements.

In the embodiments described herein monetization of the Application is achieved either by the display of advertisements, for which the advertisers pay a fee, or by the selling of a “non-advertising” embodiment to the user for which the user pays a small fee.

While the above description contains much specificity, the features described should not be construed as limitations on the scope of any embodiment, but as exemplifications of the presently preferred embodiments thereof. Many other ramifications and variations are possible within the teachings of the various embodiments. It is within the scope of the invention that the features and elements of the various embodiments described herein may be used in any combination.

Thus the scope of the invention should be determined by the appended claims and their legal equivalents, and not by the examples given.

What is claimed is:

1. A method of playing a media clip and advertisement on a cellular telephone upon the occurrence of a triggering event comprising:
Obtaining a cellular telephone having memory and a display;
Loading at least one media clip into said cellular telephone memory;
Loading at least one contact into said cellular telephone memory;
Associating said at least one media clip to said at least one contact;
Playing said media clip on a cellular telephone when said contact initiates a triggering event; and
Displaying an advertisement describing advertised offerings on said cellular telephone display during a portion of said triggering event.

2. The method of claim 1, wherein said media clip comprises a video file.

3. The method of claim 1, wherein said media clip comprises an audio file.

4. The method of claim 1, wherein said media clip is a portion of a larger media file from which a portion has been demarcated using the steps of:
Identifying said larger media file;
Demarcating a beginning point for playback;
Demarcating an ending point for playback; and
Saving that portion of said larger media file which follows after said demarcated beginning point and which comes before said demarcated end point.

5. The method of claim 1, further comprising the steps of:
Obtaining user preferences from text entered by the user during operation of the cellular telephone;
Obtaining keywords from said advertisements, said keywords describing said advertised offerings; and
Selecting said advertisement by comparing said user preferences to said keywords.

6. The method of claim 4, wherein said media clip comprises a video file.

7. The method of claim 4, wherein said media clip comprises an audio file.

8. The method of claim 5, wherein said media clip comprises a video file.

9. The method of claim 5, wherein said media clip comprises an audio file.

10. The method of claim 5, wherein said media clip is a portion of a larger media file from which a portion has been demarcated using the steps of:
Identifying said larger media file;
Demarcating a beginning point for playback;
Demarcating an ending point for playback; and
Saving that portion of said larger media file which follows after said demarcated beginning point and which comes before said demarcated end point.

11. The method of claim 9, wherein said media clip comprises a video file.

12. The method of claim 9, wherein said media clip comprises an audio file.

13. A method of playing a media clip and advertisement on a cellular telephone upon the occurrence of a triggering event comprising:
Obtaining a cellular telephone having memory, a display, and a geolocation function wherein the geolocation of the user is known;
Loading at least one media clip into said cellular telephone memory;
Loading at least one contact into said cellular telephone memory;
Associating said at least one media clip to said at least one contact;
Obtaining user preferences from text entered by the user during operation of the cellular telephone;
Playing said media clip on said cellular telephone when said contact initiates a triggering event; and
Displaying an advertisement on said cellular telephone display, wherein said advertisement is selected based upon user preferences and said geolocation of said user.

14. The method of claim 13, wherein said media clip comprises a video file.

15. The method of claim 13, wherein said media clip comprises an audio file.

16. A method of playing a media clip and advertisement on a cellular telephone upon the occurrence of a triggering event comprising:
Obtaining a cellular telephone having memory, a display, and a communication function wherein;
Said communication function communicates with an advertiser when said user is in close proximity to said advertiser;
Loading at least one media clip into said cellular telephone memory;
Loading at least one contact into said cellular telephone memory;
Associating said at least one media clip to said at least one contact;
Playing said media clip on said cellular telephone when said contact initiates a triggering event; and
Displaying an advertisement on said cellular telephone display, wherein said advertisement is selected based upon the user's proximity to said advertiser.

17. The method of claim 16, wherein said media clip comprises a video file.

18. The method of claim 16, wherein said media clip comprises an audio file.
